(19) United States
(12) Patent Application Publication
(10) Pub. No.: US 2024/0032750 A1
(43) Pub. Date: Feb. 1, 2024

(54) MESH PREFILTER FOR VACUUM DEVICE

(71) Applicant: MILWAUKEE ELECTRIC TOOL CORPORATION, Brookfield, WI (US)

(72) Inventors: Timothy J. Campbell, Brookfield, WI (US); Austin F. de Veer, Lake Orion, MI (US); Adam M. Schroeder, Waterford, WI (US)

(21) Appl. No.: 18/359,039

(22) Filed: Jul. 26, 2023

Related U.S. Application Data
(60) Provisional application No. 63/392,206, filed on Jul. 26, 2022.

(51) Int. Cl. A47L 9/12; B01D 46/00; B01D 46/10

(52) U.S. Cl. CPC A47L 9/127; B01D 46/0005; B01D 46/103; B01D 2279/55

(57) ABSTRACT

A prefilter for a filter of a vacuum device 1 includes a frame extending in an axial direction between first and second axial extents. The frame includes a base located at the first axial extent, a first cylindrical ring extending axially from the base toward the second axial extent, a plurality of ribs extending from the first cylindrical ring towards the second axial extent and defining openings between the ribs, and a second cylindrical ring portion positioned at the second axial extent of the frame. The prefilter also includes a mesh layer comprising a plurality of mesh openings, the mesh layer coupled to the frame and configured to cover the openings to prevent debris larger than a size of the mesh openings from passing therethrough. The prefilter also includes an engagement feature coupled to the frame and configured to engage the filter to fasten the frame to the filter.

### CROSS-REFERENCE TO RELATED APPLICATIONS

This application claims priority to U.S. Provisional Patent Application No. 63/392,206 filed on Jul. 26, 2022, the entire content of which is incorporated herein by reference.

### BACKGROUND

Vacuum devices such as jobsite vacuums are utilized for collecting debris (dirt, dust, soil, construction debris, and other debris) of varying sizes and consistencies. A motor powers a fan to suck air through an intake of the vacuum device. A filter captures the debris pulled through the intake and prevents it from reaching the motor to protect and extend the life of the motor of the vacuum device.

### SUMMARY

A prefilter for a filter of a vacuum device 1 includes a frame extending in an axial direction between a first axial extent and a second axial extent. The frame includes a base located at the first axial extent, a first cylindrical ring extending axially from the base toward the second axial extent, a plurality of ribs extending from the first cylindrical ring towards the second axial extent and defining openings between adjacent ones of the plurality of ribs, and a second cylindrical ring portion positioned at the second axial extent of the frame. The prefilter also includes a mesh layer comprising a plurality of mesh openings, the mesh layer coupled to the frame and configured to cover the openings to prevent debris larger than a size of the mesh openings from passing therethrough. The prefilter also includes an engagement feature coupled to the frame and configured to engage the filter to fasten the frame to the filter.

A filter assembly for a vacuum device includes a filter configured to prevent debris from passing therethrough, the filter comprising a frame member configured to directly couple to a portion of the vacuum device. The filter assembly further includes a prefilter positioned around the filter and coupled directly to the filter, the prefilter having a mesh layer comprising a plurality of mesh openings configured to prevent debris larger than a size of the mesh openings from passing therethrough. The filter and the prefilter are configured to simultaneously attach to a surface of the vacuum device by coupling the filter to the vacuum device. The filter and the prefilter are configured to simultaneously separate from the surface of the vacuum device by removing the filter from the vacuum device.

A method of using a filter assembly includes coupling a prefilter directly to a filter such that the prefilter substantially surrounds a cylindrical wall of the filter, attaching the filter directly to a surface of a vacuum device such that the prefilter is indirectly attached to the vacuum device via the filter, operating the vacuum device to draw air through the prefilter and through the filter, preventing debris of a first size from passing through the prefilter, and preventing debris of a second size, less than the first size, from passing through the filter.

### BRIEF DESCRIPTION OF THE DRAWINGS

FIG. 1 is a perspective view of a mesh prefilter for a vacuum device.

FIG. 2 is a perspective view of the mesh prefilter of FIG. 1 with a filter positioned therein.

FIG. 3 is a partial cutaway of the mesh prefilter positioned around the filter of FIG. 2.

FIG. 4 is a perspective view of a user removing the mesh prefilter of FIG. 1 from a vacuum device.

FIG. 5 is a perspective view of the mesh prefilter of FIG. 1 coupled to a vacuum device.

FIG. 6 is a further perspective view of the mesh prefilter and filter shown in FIG. 2.

FIG. 7A is a perspective view of a mesh prefilter according to another embodiment, the mesh prefilter being positioned around a filter for a vacuum device.

FIG. 7B is a perspective view of the mesh prefilter of FIG. 7A is a compressed position.

FIG. 8A is a perspective view of a mesh prefilter according to another embodiment, the mesh prefilter being positioned partially around a filter for a vacuum device.

FIG. 8B is a perspective view of the mesh prefilter of FIG. 8A.

FIG. 9A is a perspective view of a mesh prefilter according to another embodiment, the mesh prefilter being positioned partially around a filter for a vacuum device.

FIG. 9B is a perspective view of the mesh prefilter of FIG. 9A.

FIG. 10A is a perspective view of a mesh prefilter according to another embodiment, the mesh prefilter being positioned around a filter for a vacuum device.

FIG. 10B is a perspective view of the mesh prefilter of FIG. 10A.

FIG. 11A is a perspective view of a first step of a removal technique for removing the mesh prefilter and filter of FIG. 2.

FIG. 11B is a perspective view of a second step of a removal technique for removing the mesh prefilter and filter of FIG. 2.

FIG. 12 is a perspective view of a removal technique for removing the mesh prefilter of FIG. 2 from the filter of FIG. 2.

FIG. 13 is a perspective view of a further removal technique for removing the mesh prefilter of FIG. 2 from the filter of FIG. 2.

FIG. 14 is a perspective view of a further removal technique for removing the mesh prefilter of FIG. 2 from the filter of FIG. 2.

FIG. 15 is a perspective view of a further removal technique for removing the mesh prefilter of FIG. 2 from the filter of FIG. 2.

FIG. 16 is a perspective view of a further removal technique for removing the mesh prefilter of FIG. 2 from the filter of FIG. 2.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include hydraulic or electrical connections or couplings, whether direct or indirect.

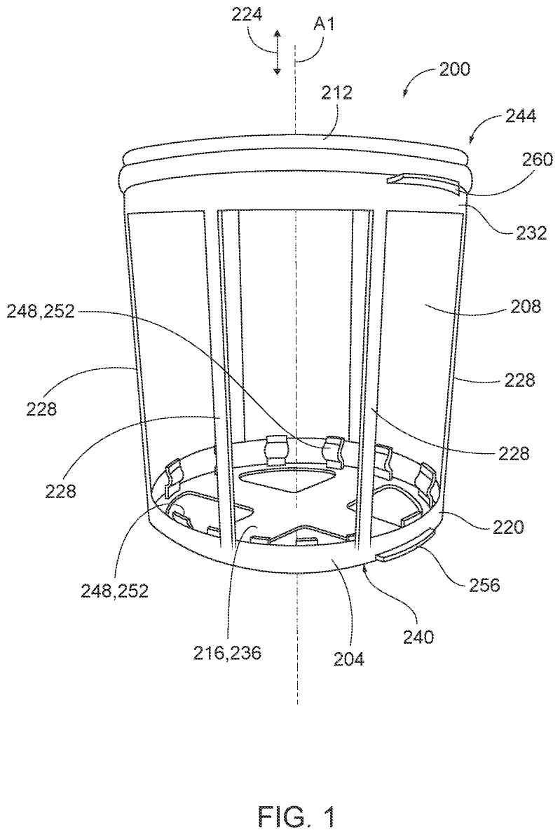

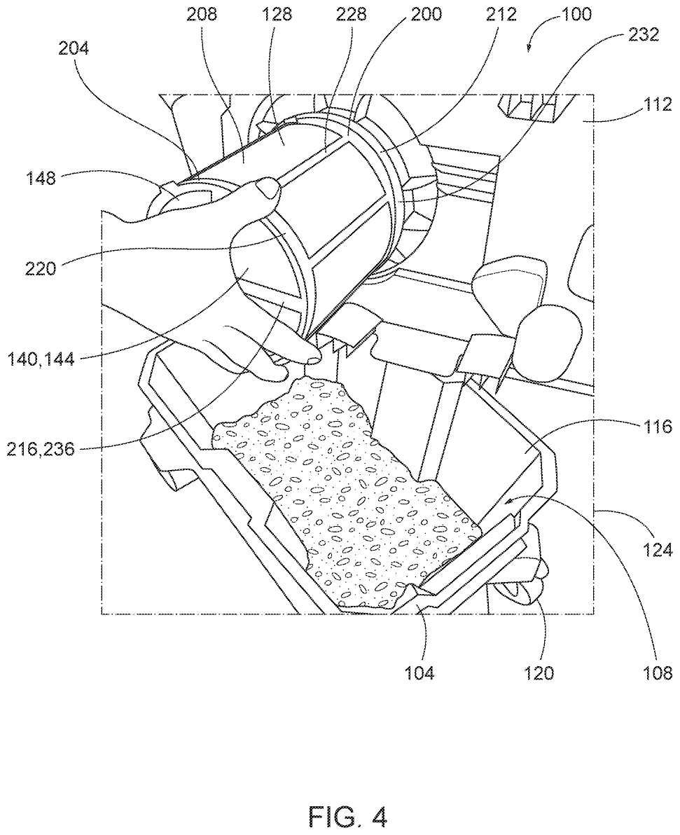

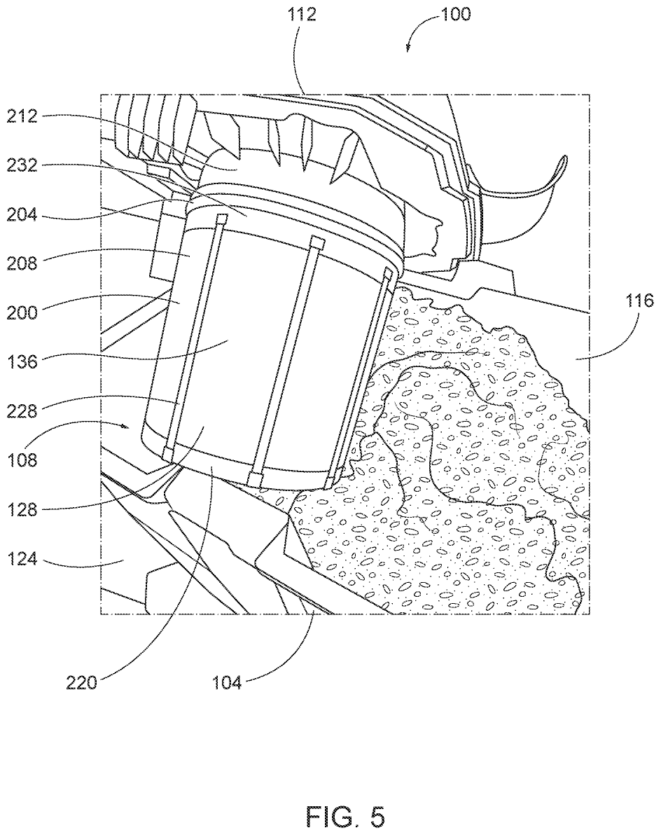

FIG. 1 is a perspective view of a mesh prefilter 200 for use with a vacuum device, such as the vacuum device 100 shown in FIGS. 4-5. Vacuum devices 100 (commonly referred to as vacuum cleaners) include a body 104 that supports a fan (not shown) and a motor (not shown) that powers the fan to draw debris through a suction inlet (not shown) of the vacuum device 100 and into a debris collection chamber 108 within the housing 104. A hose or other attachment may be coupled to the suction inlet to increase the reach and usability of the vacuum device 100. As illustrated herein, the vacuum device 100 is a wet/dry jobsite vacuum having the motor and fan incorporated into an upper body portion (i.e., lid) 112 that is mounted on a lower body portion 116 that is substantially hollow to form the debris collection chamber 108. The lid 112 is fastened to the lower body portion 116 to enclose the debris collection chamber 108. The lower body portion 116 is fastened to and supported on a plurality of wheels 120 spaced about the periphery of the lower body 116 for moving the vacuum device 100 on a ground surface 124.

The vacuum device 100 includes a power source (not shown), which may include, for example, a power cord connected to the body 104 and plugged into a household electrical outlet, or alternatively may include a rechargeable battery. A power button (not shown) electrically couples the power source to the motor so that a user can actuate the motor to power the fan and generate an airstream through the vacuum device 100.

The suction inlet is coupled to (e.g., formed in) the body 104 and functions in combination with a clean air outlet (not shown) in the lid 112 to form an air path through the body 104. Alternatively, the lid 112 could include both the suction inlet and the clean air outlet. The motor powers the fan to generate the airstream through the air path: through the suction inlet, into the debris collection chamber 108, through a filter 128, and out the clean air outlet. As shown in FIGS. 4-5, the filter 128 is coupled to the lid 112 and extends into the debris collection chamber 108 for filtering out the debris from the air in the airstream. The filter 128 defines a boundary between a debris side of the air path (the suction inlet and the debris collection chamber 108) and a clean air side of the air path (the motor, fan, and clean air outlet).

The filter 128, as shown, is a pleated paper filter that captures debris and prevents the debris from reaching the clean air side of the air path. The filter 128 includes a central cavity 132 and an array of radially extending pleats 136 that extend outward from the central cavity 132 to an outward radial extent, forming a generally tubular filter body. The filter body additionally includes frame components 140 (e.g., rigid plastic components located at the axial extents of the filter body) that provide structural support for the thin-walled and pleated filter substrate 136. A first frame component 144 is a circular plate located at one axial extent 148 of the pleated filter 136 and covers the underside of the filter 128 to prevent debris from circumventing the pleats 136 via the underside of the filter 128. A second frame component 152 located at the opposite axial extent 156 of the pleated filter 136 has a ring-shaped cross-section with a central opening 160 providing access to the central cavity 132 of the filter 128.

The filter 128 is mounted to the underside of the lid 112 such that the second frame component 152 is coupled to the lid 112 at the air path formed therein. As such, the clean air side of the air path is in fluid communication with the inside of the filter 128 via the central opening 160. Other types of filters may be utilized depending on the type of vacuum device 100, the environment in which the vacuum device 100 is being utilized, and/or the type of debris that is being collected by the vacuum device 100.

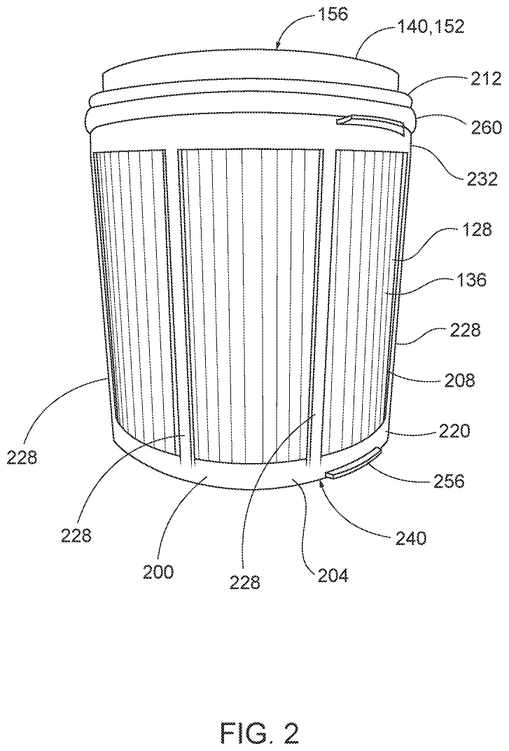

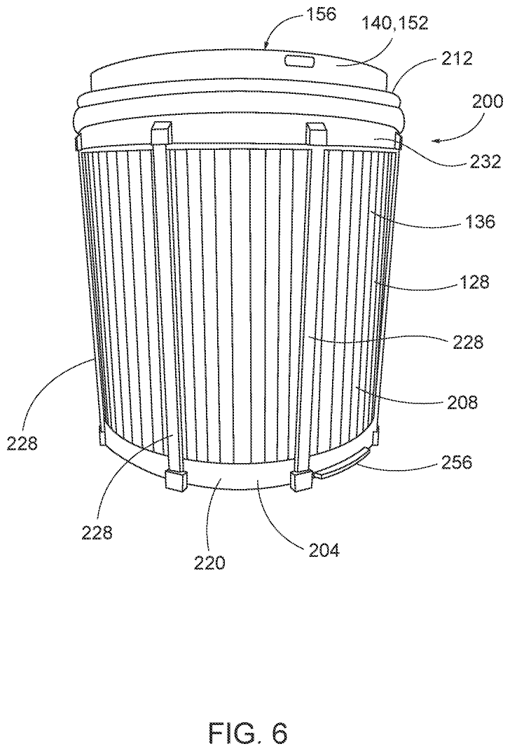

In some instances, such as when working with certain materials (e.g., blown-in insulation, wood debris, fibers and large pieces of debris, debris larger than dust particles, etc.), the filter 128 can become blocked with debris pressed against or within the pleats 136 of the filter 128. Blockages decrease airflow through the filter 128, thereby decreasing suction through the suction inlet. To prevent debris from interacting with and blocking the filter 128, a mesh prefilter 200 as shown in FIGS. 1-6, is provided. The mesh prefilter 200 extends around the outside of the filter 128 as shown in FIG. 2 so that when the filter 128 is installed within the vacuum device 100 (FIGS. 4-5), the prefilter 200 is located between the filter 128 and the debris within the debris collection chamber 108.

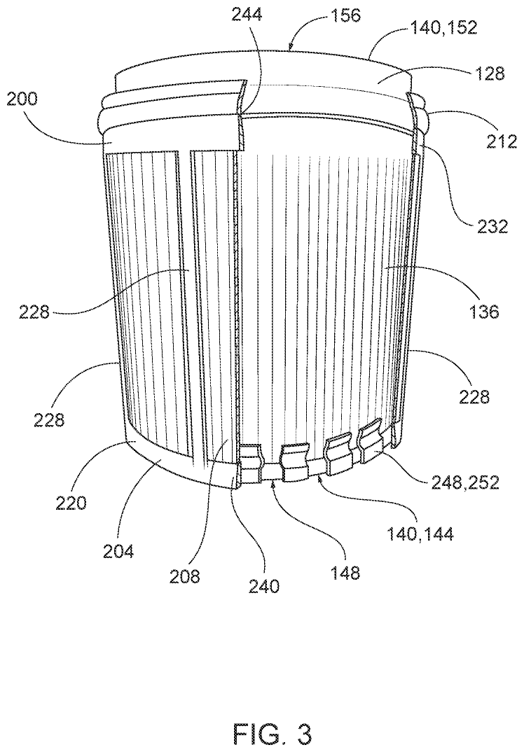

As shown in detail in FIGS. 2-3 and 6, the mesh prefilter 200 has a similar shape as the filter 128 and is sized larger than the filter 128 so that it fits around the filter 128 with a small gap (e.g., approximately up to 1/16 inch, ⅛ inch, ¼ inch, ½ inch, ¾ inch, or 1 inch) between the inside of the mesh prefilter 200 and the outside of the filter 128. The prefilter 200 includes a frame 204, a mesh layer 208, and a seal 212. The frame 204 is a skeleton that provides structure and stability for the remainder of the prefilter 200 and includes a base 216, a lower cylindrical ring 220 extending in a longitudinal direction 224 from the base 216, axial ribs 228 extending in the longitudinal direction 224 from the lower cylindrical ring 220, and an upper cylindrical ring 232 coupled to the axial ribs 228 opposite the lower cylindrical ring 220. The base 216 is formed as an X, with two crossed braces 236 coupled to the lower cylindrical ring 220 to hold the circular shape of the lower cylindrical ring 220. The base 216 is located at a first axial extent 240 of the frame 204. The lower cylindrical ring 220 extends axially from the base 216 towards the second axial extent 244 (FIG. 3) of the frame 204. The lower cylindrical ring 220 has a thin walled (relative to the height in the axial direction) circular cross-section centered about the longitudinal axis A1 (FIG. 1) of the prefilter 200.

A plurality (e.g., 6, 8, 10, or 12) of axial ribs 228, as shown eight axial ribs 228, extend in the longitudinal direction 224 between the two cylindrical rings 220, 232. The axial ribs 228 extend a majority (e.g., greater than 50%, 75%, or 90%) of the axial length of the frame 204 and define substantially the entire axial length of the frame 204. The axial ribs 228 have a thickness similar to the thickness of the cylindrical rings 220, 232 and base 216 and have a thickness sufficient to provide support along the length of the prefilter 200 without substantially covering surface area of the cylindrical surface of the prefilter 200. As shown, each axial rib 228 has a width that accounts for approximately 1-2 percent of the diameter of the prefilter 200. Written another way, when viewing the circular cross-section of the prefilter 200, each rib 228 extends approximately five degrees along the circular profile. With eight total ribs 228 equally spaced about the circular profile, the ribs 228 are each separated by approximately 40 degrees. As such, the ribs 228 cover less than 20 percent of the total surface area of the cylindrical sidewall profile of the prefilter 200, with the remaining percentage between the ribs 228 left open for the mesh layer 208.

The frame 204 further includes an engagement feature 248 for coupling to the filter. In the embodiment shown in FIGS. 1 and 3, the engagement feature 248 includes a plurality (as shown, twelve) retention clips 252 coupled to the frame 204 (e.g., the base 216, the lower cylindrical ring 220) near the first axial end 240 of the prefilter 200. The retention clips 252 extend axially from the base 216 into an interior volume of the prefilter 200 adjacent to the outer periphery of the prefilter 200. The clips 252 are shaped to elastically deform to extend around a lower lip (e.g., first frame component 144) of the filter 128 and are biased to collectively engage the filter 128 when surrounding the lower lip. As such, the engagement feature 248 holds the prefilter 200 relative to the filter 128 while in use. In other embodiments, the engagement feature 248 may be incorporated as different attachment methods such as a twist lock engagement feature or a press/interference fit.

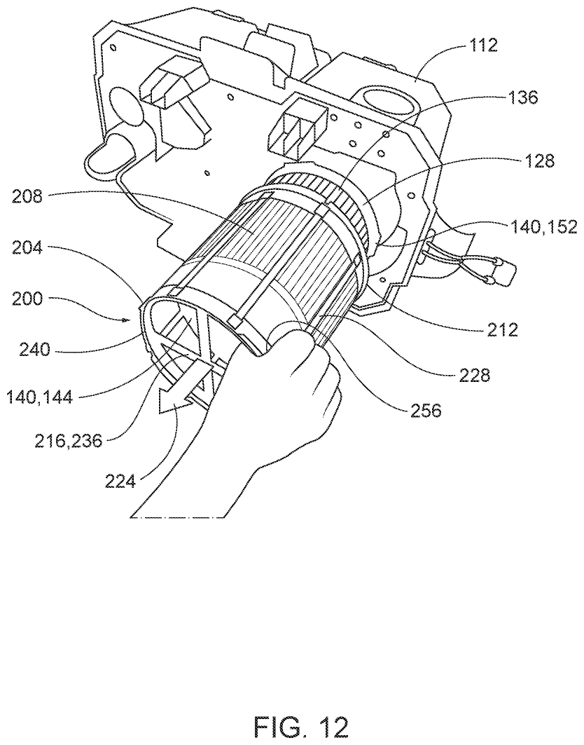

First and second finger holds 256, 260 are coupled to (e.g., integrated into) the frame 204 and provide points for a user to grasp the prefilter 200 for removing the prefilter 200 from the filter 128, as shown in FIGS. 12-16. The finger holds 256, 260 extend radially outward from the frame 204 adjacent to the first and second axial extents 240, 244 of the frame. Each finger hold 256, 260 is sized to allow a user to place one, two, or three fingers thereon for applying an axial force to the prefilter 200 to overcome the holding force of the engagement feature 248.

A seal 212 is located at or above the upper cylindrical ring 232 (opposite the direction of the ribs 228 extending from the upper cylindrical ring 232) and extends around the entire upper periphery of the frame 204 to form a seal. When seated within the vacuum device 100, the seal 212 deforms to form an airtight seal with the lid 112 of the vacuum device 100 or the external face of the second frame component 152 to prevent debris from bypassing the prefilter 200 at a location between the prefilter 200 and the lid 112 or between the prefilter 200 and the second frame component 152. The seal 212 may be formed of a rubber or other elastomeric, deformable material configured to produce a seal between rigid plastic components. The seal 212 may be coupled to the frame 204 via, for example, an adhesive, a press fit, or an interlocking connection between the upper cylindrical ring 232 and the seal 212. In other embodiments, the seal 212 may be coupled to the lid 112 or the filter. In still other embodiments, the seal 212 may be omitted.

The mesh layer 208 of the prefilter is formed of a metal or plastic material having a consistent mesh pattern across the entire layer 208. The openings formed in the mesh material are sized to prevent large debris such as construction debris from passing therethrough and reaching (and clogging) the pleated filter 128. In some embodiments, the size of the openings in the mesh layer 208 are large enough to permit fine materials such as fine wood dust, concrete/silica dust, drywall/gypsum dust and ashes to pass therethrough and to the filter 128. Larger materials such as coarse wood dust, cellulose, larger tile and drywall debris, and other large jobsite debris is too large to pass through the openings in the mesh layer 208. The mesh layer 208 may have opening sizes on the scale of 600 microns (e.g., 550-650 microns, 500-700 microns, 400-800 microns, 500-600 microns, or 400-600 microns). The opening sizes of the mesh layer 208 are significantly larger (e.g., 100 times larger, 50-200 times larger) than the openings or pores (e.g., 2-10 microns) through the filter 128 (i.e., the pleated paper of a pleated paper filter).

The mesh layer 208 is positioned within the frame 204 and is rolled into a generally cylindrical form having an outer diameter similar to an inner diameter of the frame 204 of the prefilter 200. With the mesh layer 208 positioned within the frame 204, large debris is prevented from passing through the cylindrical wall of the prefilter 200 and to the filter 128, though airflow through the cylindrical wall is still permissible through the mesh layer 208 between the axially extending ribs 228. The mesh layer 208 may be fastened to the frame 204 via a fastener (e.g., clips, threaded fasteners, positive engagement with a recess or slot in the frame, friction welding, adhesives, or the like).

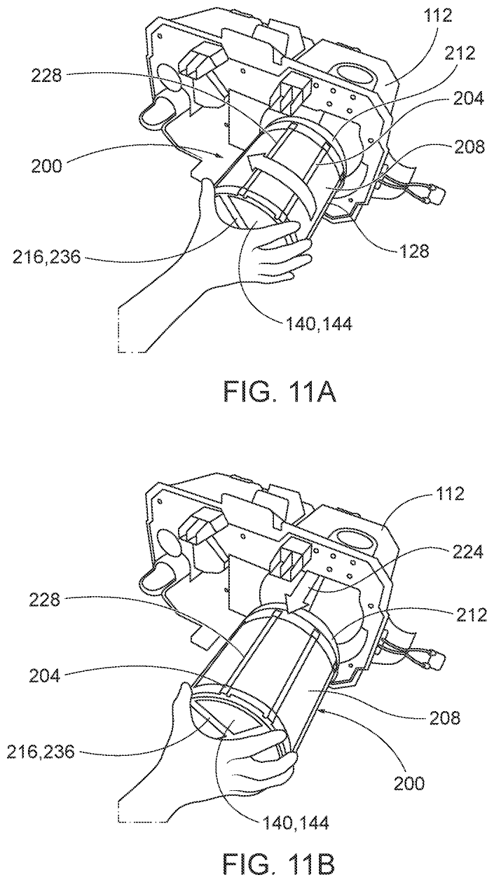

FIGS. 11A-11B illustrate a method of simultaneously removing the prefilter 200 and the filter 128 from the housing 104 of the vacuum device 100. In the embodiment shown, only the filter 128 is attached directly to the housing 104 with the prefilter 200 attached indirectly to the housing 104 by its attachment to the filter 128. The filter 128 engages the housing 104 of the vacuum device 100 via a twist-lock arrangement. As such, to remove the filter 128 and prefilter 200, the user engages the frame 204 of the prefilter 200 and rotates the prefilter 200 relative to the housing 104. The interaction between the engagement feature 248 of the prefilter 200 and the filter 128 is strong enough such that rotation of the prefilter 200 results in similar rotation of the filter 128. With the filter 128 and prefilter 200 rotated such that the twist-lock feature of the filter 128 is disengaged from the housing 104 of the vacuum device 100, the filter 128 and prefilter 200 are moved along the shared axis A1 (FIG. 1) of the filter 128 and prefilter 200 in the axial direction 224 away from the housing 104 to complete the removal of the filter 128 and prefilter 200. As such, removal of the prefilter 200 and filter 128 follows the same method of removing only the filter 128. Assembly of the filter 128 and prefilter 200 to the housing 104 of the vacuum device 100 follows the removal steps outlined above, but in reverse.

FIG. 12 illustrates a method of removing the prefilter 200 from the filter 128 when both the prefilter 200 and the filter 128 are attached to the housing 104 of the vacuum device 100. A user engages one or more of the finger holds 256, 260 adjacent the distal ends (as shown in FIG. 12, the first distal end 240 adjacent the base 216) and pulls axially to overcome the force between the engagement feature 248 and the filter 128. In the example shown, the user grasps the frame 204 at the finger hold 256 with a plurality of fingers, and pushes against the underside of the filter 128 (through the gaps between the crossed braces 236 of the base 216) with a thumb to generate the force to remove the prefilter 200 from the filter 128.

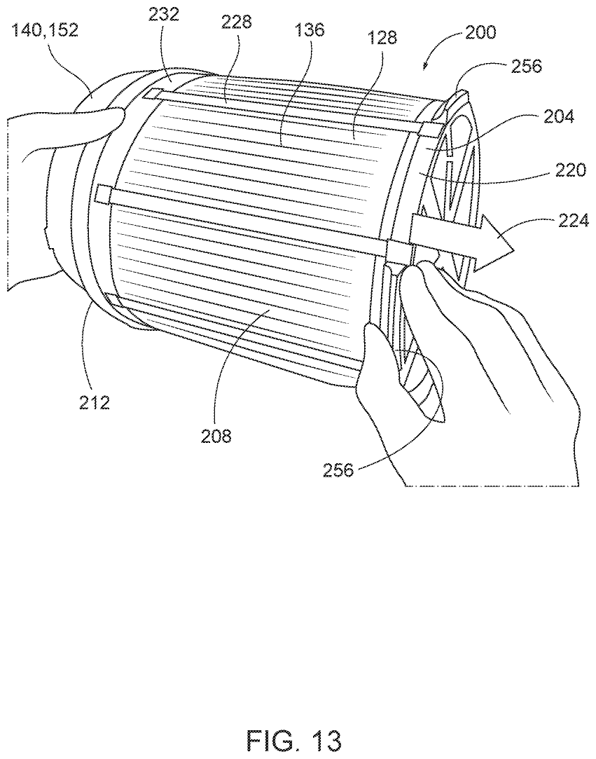

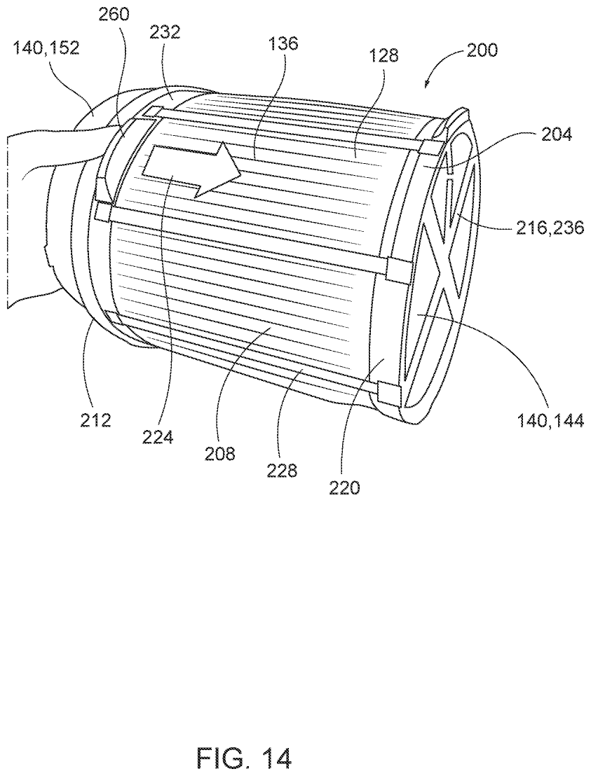

FIGS. 13-16 illustrate methods of removing the prefilter 200 from the filter 128 when the filter 200 and prefilter 128 are removed from (or otherwise not coupled to) the housing 104 of the vacuum device 100. As shown in FIG. 13, a user holds the top end of the filter 128 with a first hand, the first hand extending into the central cavity 132 of the filter 128 as a handhold. Simultaneously, the second hand grasps the finger hold 256 at the first distal end 240 of the prefilter 20 and, similar to the method shown in FIG. 12, axially pulls the prefilter 200 away from the filter 128, overcoming the force generated by the interaction between the engagement feature 248 and the filter 128. FIG. 14 illustrates a one-handed method of removing the prefilter 200 from the filter 128. The hand of the user engages the filter 128 and is inserted into the central cavity 132 of the filter 128, similar to FIG. 13, and the thumb of the same hand engages the finger hold 260 adjacent the second distal end 244 of the prefilter 200 to axially push the prefilter 200 relative to the filter 128 to displace the engagement feature 248 and separate the filter 128 from the prefilter 200.

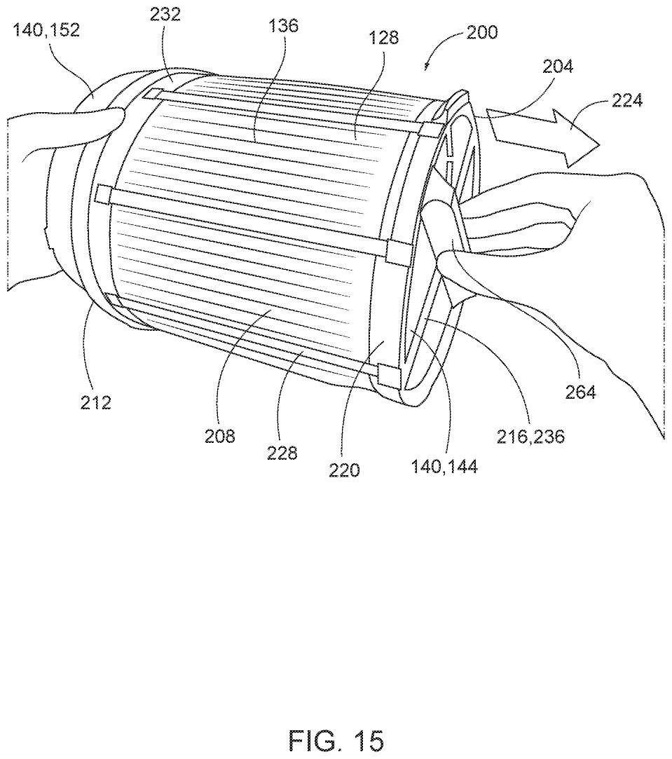

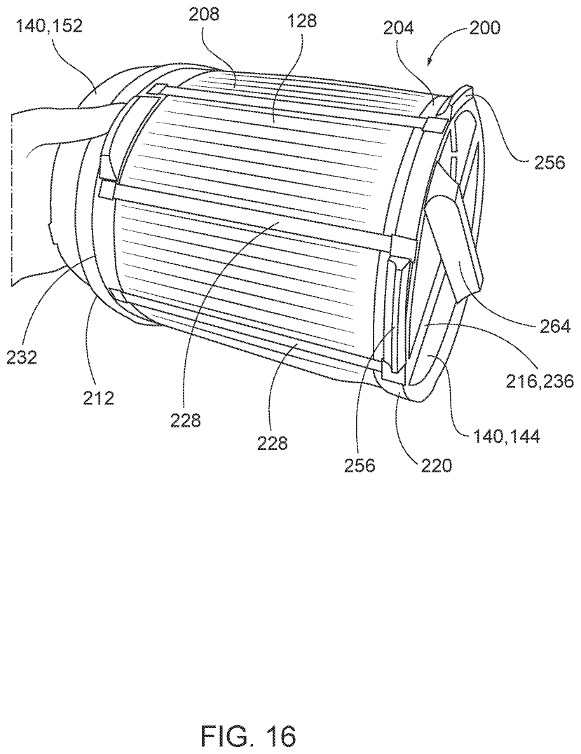

FIG. 15 incorporates a separate finger hold 264 located on the base 216 and extending axially from the base 216 away from the remainder of the prefilter 200. As shown, the finger hold 264 extends along one of the crossed braces 236 across substantially the entire diameter of the prefilter 200. The finger hold 264 also functions to increase the thickness of the crossed brace 236, thereby strengthening the frame 204 against radial deflection, especially near the base 216. To remove the prefilter 200 as shown in FIG. 15, the user grasps the filter 128 with a first hand in a similar manner as described with respect to FIG. 12, and grasps the finger hold 264 with a second hand. A plurality of fingers of the second hand are positioned on one side of the finger hold 264 and the thumb of the second hand is positioned on the opposite side of the finger hold 264 to grasp and pull the finger hold 264, displacing the engagement feature 248 relative to the filter 128 and separating the filter 128 from the prefilter 200. The finger hold 264 can also be utilized as a handle for twisting the filter 128 and prefilter 200 to remove the filter 128 and prefilter 200 from the vacuum device 100 in a scenario similar to that described with respect to FIGS. 11A-11B. FIG. 16 illustrates an embodiment having the finger holds 256, 260 that extend radially outward from the frame 204 and the finger hold 264 extending axially from the base 216. A user can separate the prefilter 200 of FIG. 16 from the filter 128 in a plurality of different ways including those shown in FIGS. 13-15 or a combination of the same.

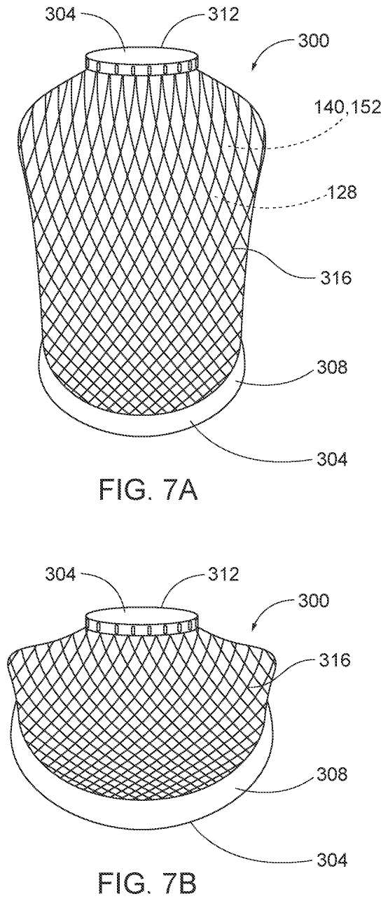

FIGS. 7A-7B illustrate a mesh prefilter 300 according to another embodiment and, as shown in FIG. 7B, is a collapsible mesh prefilter. The mesh prefilter 300 includes a frame 304 comprising a cylindrical ring portion 308 similar to the lower cylindrical ring portion 220 shown in FIG. 1 and a circular cap 312 spaced apart from the cylindrical ring portion 308. A mesh layer 316 that extends between the two portions 308, 312 of the frame 304 to couple them together. The frame 304 is formed of a substantially rigid material similar to the frame 204 illustrated in FIG. 1. The prefilter 300 omits a rigid frame component extending along the axial length of the prefilter 300, which allows the prefilter 300 to collapse into a smaller size for packaging, shipping, or storing, when not surrounding a filter 128. The mesh layer 316 is biased to the shape shown in FIG. 7A based on the material properties (e.g., ductility, elasticity) of the mesh layer 316 as well as the way in which the mesh layer 316 is coupled to the frame 304. As shown, the mesh layer 316 is coupled to the cylindrical ring portion 308 such that it extends axially therefrom. The mesh layer 316 is coupled to the circular cap 312 at an angle transverse to the axial direction and transverse to the way in which the opposite end is coupled to the cylindrical ring 308, thereby providing structure to the mesh layer 316. The prefilter 300 may include an engagement feature (not shown) similar to that described above or may otherwise utilize an alternative engagement feature such as a press fit around the filter achieved by axially deforming the prefilter 300 into a larger cross-section when assembling the prefilter 300 to the filter 128.

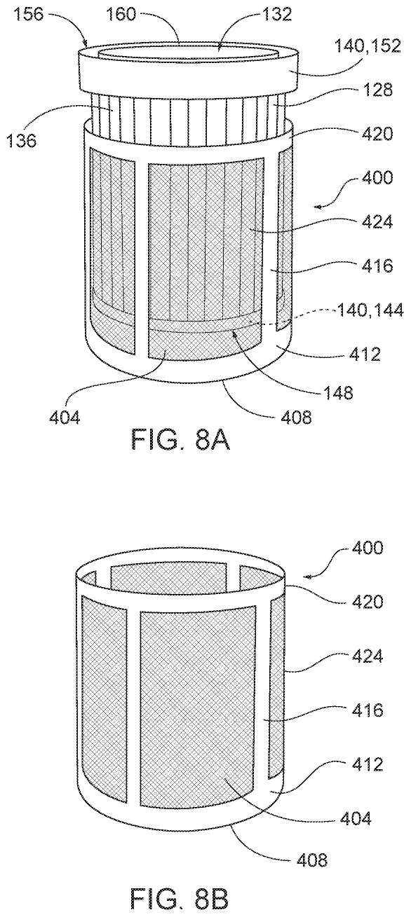

FIGS. 8A-8B illustrate a prefilter 400 similar to the prefilter 200 shown in FIGS. 1-6. In contrast to the prefilter 200, the prefilter 400 includes a solid base 404 at the first distal end 408 rather than the crossed braces 236. The solid base 404 couples to the lower cylindrical ring portion 412 at the entire periphery of the lower cylindrical ring portion 412, providing no gaps therethrough. The axial ribs 416, upper cylindrical ring portion 420, and mesh layer 424 are similar to their counterparts shown in FIGS. 1-6.

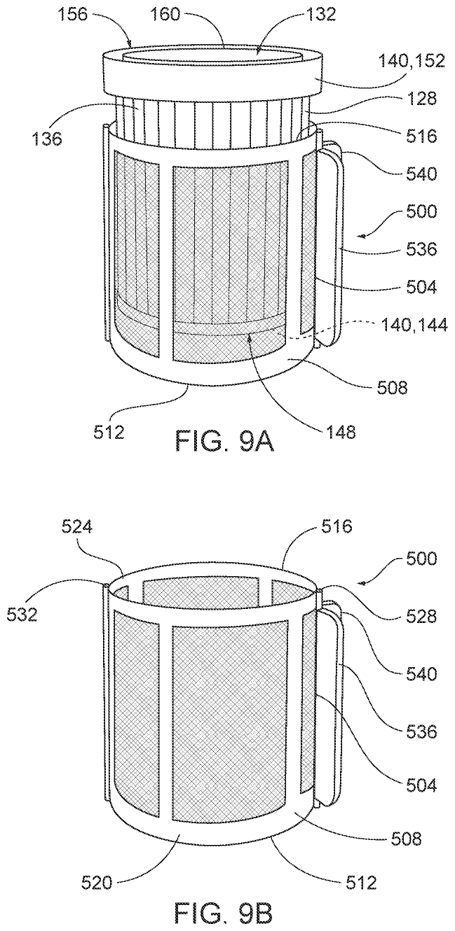

FIGS. 9A-9B illustrate a still further prefilter 500. The prefilter 500 includes a similar cylindrical shape described above with respect to FIGS. 1-6, though includes a hinge 504 extending in the axial direction along the outer periphery of the frame 508. The hinge 504 extends from a first axial extent 512 of the frame 508 to the opposite second axial extent 516. The hinge 504 connects two halves 520, 524 (bisecting the generally cylindrical shape into two semicylinders each comprising approximately 180 degrees of the circular cross-section) of the prefilter 500 together at a first axially extending intersection 528 between the two halves 520, 524. The second intersection 532 between the two halves 520, 524 may have no interconnection or contact in some embodiments, may overlap in other embodiments, and may be coupled together with fasteners (e.g., clasps) in yet other embodiments. The hinge 504 may be biased to a closed position via a biasing member (e.g., spring; not shown) so that the prefilter 500 presses around the filter 128 (when placed around the filter 128) from all sides by the biasing member. The prefilter 500 further includes finger holds 536, 540 extending axially about either side of the hinge 504. As a user presses the finger holds 536, 540 towards one another, the spring bias is overcome, separating the two halves 520, 524 of the prefilter 500 at the second intersection 532, thereby separating the prefilter 500 from the filter 128.

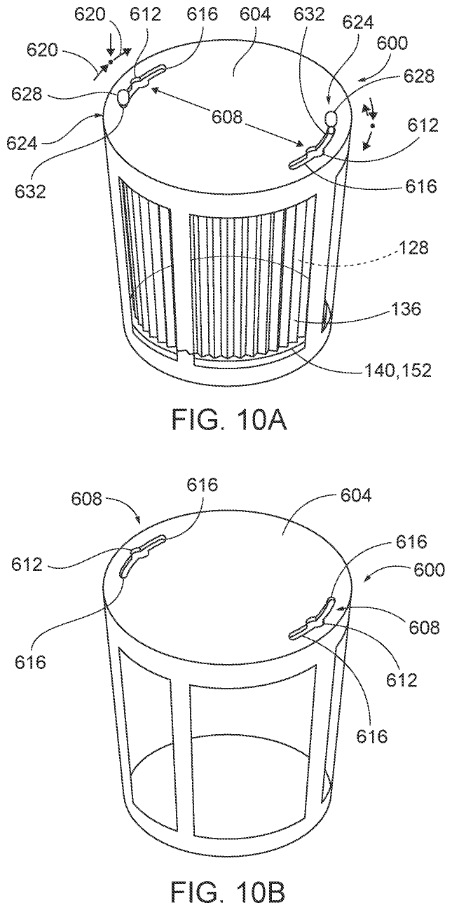

FIGS. 10A-10B illustrate a still further embodiment of a prefilter 600, similar to FIGS. 1-6 except as otherwise described. The base 604 of the prefilter 600 differs from the crossed braces 236 shown in FIGS. 1-6, instead including a solid base 604 similar to that shown in FIGS. 8A-8B, and omits the retention clips 252. In place of the retention clips 252, the base 604 includes keyed slots 608 (as shown, two keyed slots) having an opening 612 and one or more slots 616 extending from opening 612 in a circumferential direction 620, the slots 616 having a narrower width (in the radial direction) than the width of the opening 612. The keyed slots 608 engage protrusions 624 extending axially from the filter 128. The protrusions 624 include a large distal head 628 and a thinner neck 632, the head 628 having a width (as measured in the radial direction) greater than the width of the slots 616 but less than the width of the opening 612. The neck 632 has a width (measured in the same radial direction) thinner than both of the slots 616 and the openings 612. To couple the prefilter 600 to the filter 128, the prefilter 600 is translated axially to surround the filter 128, with the protrusions 624 aligned with the openings 612 in the base 604 so that the heads 628 of the protrusions 624 are translated axially through the openings 612. The prefilter 600 is then rotated relative to the filter 128 so that the necks 632 of the protrusions 624 are positioned within the slots 616 of the prefilter 600. In this position, the prefilter 600 is prevented from axial removal from the filter 128 based on the interaction between the heads 628 of the protrusions 624 and the slots 616. The slots 616 may include a detent or other locking feature to prevent accidental rotation of the prefilter 600 relative to the filter 128.

Utilizing the prefilter 200 (or alternatively one of the other prefilters 300, 400, 500, 600) increases the amount of time that the vacuum device 100 can be used without stopping to clean the filter 128. In testing, the prefilter 200 blocks debris that would otherwise pass through to the filter 128 and more easily sheds the debris into the collection bin than if the debris would have collected on the filter 128. As a result, the filter 128 is cleaned 2-12 times less frequently (dependent upon the type and size of debris being suctioned) when used in combination with the prefilter 200 as opposed to when used without a prefilter 200. In addition, the amount of time and effort necessary to clean the filter 128 is decreased when used in combination with the prefilter 200, increasing the efficiency of use of the vacuum device 100.

What is claimed is:

1. A prefilter for a filter of a vacuum device, the prefilter comprising:
a frame extending in an axial direction between a first axial extent and a second axial extent, the frame comprising a base located at the first axial extent, a first cylindrical ring extending axially from the base toward the second axial extent, a plurality of ribs extending from the first cylindrical ring towards the second axial extent and defining openings between adjacent ones of the plurality of ribs, and a second cylindrical ring portion positioned at the second axial extent of the frame;
a mesh layer comprising a plurality of mesh openings, the mesh layer coupled to the frame and configured to cover the openings to prevent debris larger than a size of the mesh openings from passing therethrough; and
an engagement feature coupled to the frame and configured to engage the filter to fasten the frame to the filter.

2. The prefilter of claim 1, further comprising a seal positioned at the second axial extent of the frame, the seal configured to provide an airtight seal between the second cylindrical ring of the frame and a surface of the vacuum device.

3. The prefilter of claim 1, further comprising a finger hold separate from the engagement feature, coupled to the frame, and engageable by a hand of a user for uncoupling the engagement feature from the filter via movement of the prefilter along the axial direction.

4. The prefilter of claim 1, wherein the engagement feature includes a plurality of retention clips configured to engage a lip of the filter.

5. The prefilter of claim 1, wherein the prefilter is removable from the filter.

6. The prefilter of claim 1, wherein the frame is generally cylindrical and has an open end sized to receive the filter at the second axial extent.

7. The prefilter of claim 1, wherein the filter includes a frame member and a pleated paper filter coupled to the frame member and configured to prevent debris from passing therethrough, wherein the engagement member is configured to directly couple to the frame member of the filter.

8. The prefilter of claim 1, further comprising a first finger hold adjacent the first axial extent and engageable by a first hand of a user and a second finger hold adjacent the second axial extent and engageable by a second hand of the user, wherein both finger holds are simultaneously engageable for uncoupling the engagement feature from the filter via movement of the prefilter along the axial direction.

9. A filter assembly for a vacuum device, the filter assembly comprising:
a filter configured to prevent debris from passing therethrough, the filter comprising a frame member configured to directly couple to a portion of the vacuum device; and
a prefilter positioned around the filter and coupled directly to the filter, the prefilter having a mesh layer comprising a plurality of mesh openings configured to prevent debris larger than a size of the mesh openings from passing therethrough;
wherein the filter and the prefilter are configured to simultaneously attach to a surface of the vacuum device by coupling the filter to the vacuum device, and
wherein the filter and the prefilter are configured to simultaneously separate from the surface of the vacuum device by removing the filter from the vacuum device.

10. The filter assembly of claim 9, wherein the prefilter comprises an engagement feature configured to engage the frame of the filter to fasten the frame to the filter.

11. The filter assembly of claim 10, wherein the prefilter is configured to uncouple from the filter by uncoupling the engagement feature when the filter is attached to the surface of the vacuum device and when the filter is detached from the surface of the vacuum device.

12. The filter assembly of claim 10, wherein the engagement feature includes a plurality of retention clips configured to engage a lip of the filter.

13. The filter assembly of claim 9, wherein the filter assembly has a substantially circular cross-section extending between a first axial extent and a second axial extent, the filter assembly further comprising a seal positioned at the second axial extent of the frame, the seal configured to provide an airtight seal between the second cylindrical ring of the frame and the surface of the vacuum device.

14. The filter assembly of claim 9, wherein the prefilter comprises a finger hold engageable by a hand of a user for uncoupling the prefilter from the filter via movement of the prefilter along an axial direction.

15. The filter assembly of claim 9, wherein the prefilter is removable from the filter.

16. The filter assembly of claim 9, wherein the filter includes a pleated paper filter coupled to the frame member and configured to prevent the debris from passing therethrough.

17. A method of using a filter assembly, the method comprising:
coupling a prefilter directly to a filter such that the prefilter substantially surrounds a cylindrical wall of the filter;
attaching the filter directly to a surface of a vacuum device such that the prefilter is indirectly attached to the vacuum device via the filter; and
operating the vacuum device to draw air through the prefilter and through the filter;
preventing debris of a first size from passing through the prefilter; and
preventing debris of a second size, less than the first size, from passing through the filter.

18. The method of claim 17, wherein coupling the prefilter directly to the filter includes engaging a plurality of retention clips of the prefilter with a frame of the filter.

19. The method of claim 17, wherein coupling the prefilter directly to the filter includes engaging a finger hold of the prefilter to axially translate the prefilter relative to the filter.

20. The method of claim 17, wherein attaching the filter directly to a surface of the vacuum device includes compressing a seal of the prefilter against the surface of the vacuum device to prevent debris from circumventing the prefilter.
